(19) United States
(12) Patent Application Publication
(10) Pub. No.: US 2005/0156720 A1
(43) Pub. Date: Jul. 21, 2005

(54) Tire condition display device

(75) Inventor: Atsushi Ogawa, Toyota-shi (JP)

Correspondence Address: OLIFF & BERRIDGE, PLC, P.O. BOX 19928, ALEXANDRIA, VA, 22320, US

(73) Assignee: TOYOTA JIDOSHA KABUSHIKI KAISHA, Aichi-ken (JP)

(21) Appl. No.: 11/023,006

(22) Filed: Dec. 28, 2004

(30) Foreign Application Priority Data
Jan. 13, 2004 (JP) 2004-006139

(51) Int. Cl. B60C 23/00

(52) U.S. Cl. 340/442

(57) ABSTRACT

A tire condition display device is disclosed. The device comprises plural sensors for detecting tire condition, each of the sensors being mounted at a wheel of a vehicle and having a different identification sign at an observable place; a transmitter mounted at each wheel, for transmitting the tire condition information detected by the sensor and the identification sign; a user input unit for receiving corresponding relations between the identification signs and corresponding wheel locations in the vehicle; and a display unit for displaying the tire condition information and corresponding wheel locations, based on the received corresponding relations.

### BACKGROUND OF THE INVENTION

1. Field of the Invention

The present invention relates to a tire condition display device capable of showing tire condition information such as tire air pressure detected by a sensor mounted at each wheel, together with the corresponding tire locations in a vehicle.

2. Description of the Related Art

In order to drive a car safely, it is necessary to keep wheel conditions including tire conditions normal. Therefore, when an abnormal condition such as low tire air pressure occurs in a wheel, the abnormal condition should be immediately detected and treated properly.

As a prior technology for alerting a user to abnormal conditions occurring in tires, Patent Reference 1 discloses a tire pressure monitoring system comprising a tire pressure alarming lamp corresponding to the wheel location. Patent Reference 2 discloses a technology in which plural tires are provided with sensors having different identification signs. When a tire has abnormally low air pressure, the identification sign attached to a sensor which detects the abnormal condition is displayed on a display.
Patent Reference 1: Japanese Laid-Open Patent Application 8-505939
Patent Reference 2: Japanese Laid-Open Patent Application 2001-80321

In the tire pressure monitoring system disclosed in Patent Reference 1, however, a card of each transmitter for transmitting tire pressure information is programmed relating to its tire mounting location, and therefore after tire rotation, it is required to determine again the locations of tires. It is necessary to correctly input tire locations before and after the tire rotation. If such input is wrong, tire conditions cannot be detected correctly, and further there is no way of confirming the correct wheel locations.

In the technology disclosed in Patent Reference 2, when an abnormal condition occurs, a user has to find out which tire has the same identification sign as that shown on the display unit. Therefore it is impossible to identify the abnormal wheel-location without getting out of the car.

### SUMMARY OF THE INVENTION

Accordingly, the present invention is made in view of the above-mentioned problems, and aims at offering a tire condition display device in which tire condition information detected by sensors mounted at wheels in a vehicle is displayed together with the corresponding tire mounting locations, and such corresponding relations can be easily input.

According to one aspect of the present invention, a tire condition display device is disclosed. The tire condition display device comprises: a plurality of sensors for detecting tire conditions, each of the sensors being mounted at a wheel of a vehicle and having a different identification sign at an observable place; a transmitter mounted at each wheel, for transmitting the tire condition information detected by the sensor and the identification sign information; a user input unit for receiving corresponding relations between the identification signs and their corresponding wheel locations in the vehicle; and a display unit for displaying the tire condition information and the corresponding wheel locations, based on the received corresponding relations.

The expression “tire condition” means herein a physical value detected by a sensor mounted at a wheel, such as tire air pressure, tire temperature, wet/dry information of road-holding face, tire wearing amount, acceleration, tire distortion, and so on. The expression “identification signs” means any observable signs that a user can easily understand and memorize, for example such as colors, numeric figures, symbols, alphabet letters, figures, and so on. The identification signs should be attached to an irremovable portion of a tire. The “user input unit” includes buttons and touch panels. The “display unit” may be an LCD provided within the interior of the car, and may be an LED or a screen used in a car navigation system. If a transmitter is provided for transmitting information to outside of the car, a monitor screen of a handy type checking device is included in the “display unit”.

According to an embodiment of the present invention, tire condition information and corresponding identification signs are transmitted from the wheel, and a user can input corresponding relations between the wheel mounting locations and the identification signs. Therefore, the tire condition display device can display the tire condition information together with the corresponding tire locations on the display unit.

The display unit may show corresponding relations between the identification signs and wheel locations, whereby a user can visually confirm the corresponding relations when inputting.

The “user” includes not only a driver, but also a worker in a fabricating factory or maintenance facility.

The tire condition display device may further comprise a determining unit for determining tire abnormal conditions based on the tire condition information. In this case, the display unit displays the location of the tire determined to be abnormal. A user can immediately grasp the location of the tire in which the abnormal condition occurs.

In case a where each of the sensors is previously assigned a unique identification number, the identification signs and the identification numbers can be related to each other. In this case, the car receives the sensor identification number, and the identification signs are also available. Therefore, it is not required anymore to transmit the identification signs from the wheels to the car, and the amount of data communicated is reduced.

In a tire condition display device according to the present invention, tire condition information detected by a sensor mounted at a wheel can be displayed together with the location of the wheel, and corresponding relations between the identification signs and the locations of the wheel can be easily obtained.

### BRIEF DESCRIPTION OF THE DRAWINGS

FIG. 1 generally shows a tire condition display system according to one embodiment of the present invention;

FIG. 2 illustrates the location of an identification sign attached to an air valve;

FIG. 3 is a block diagram showing a structure relating tire air pressure information display in an ECU;

FIG. 4 is a flowchart illustrating a procedure for displaying and providing alarm for tire air pressure information;

FIG. 5 shows an example of an identification sign setting screen; and

FIG. 6 shows an example of a tire air pressure display screen.

### DESCRIPTION OF THE PREFERRED EMBODIMENTS

In the following, embodiments of the present invention are described with reference to the accompanying drawings.

According to one embodiment of the present invention, in a tire condition display system incapable of identifying tires provided with sensors based only on information transmitted from the tires, an identification sign is attached to an air valve of each tire. After replacing tires, a user inputs the corresponding relation between the identification sign and its tire's location (FR, FL, RR and RL) in a car, so that air pressure of each tire can be displayed with its tire's location in the car.

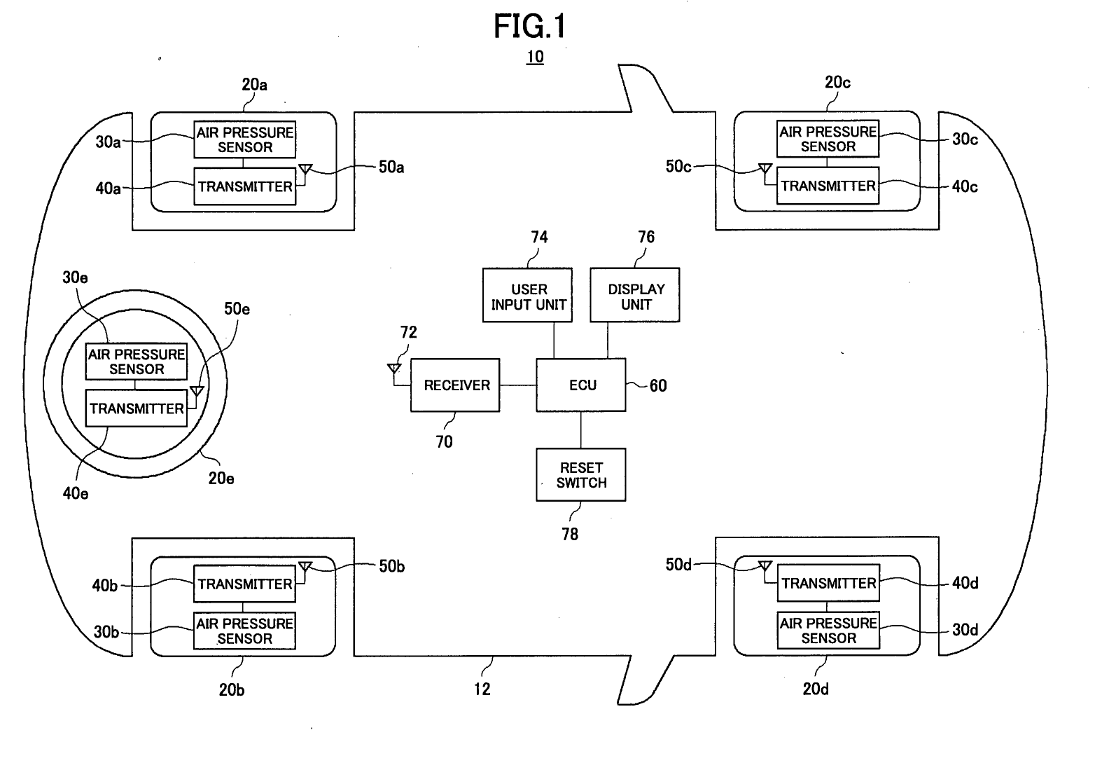

FIG. 1 generally shows a car 12 comprising a tire condition display system 10 according to one embodiment of the present invention. To each of four wheels and a spare tire of the car 12, an air pressure sensor for detecting the air pressure of its tire, a transmitter for transmitting the tire air pressure detected by the air pressure sensor to the car, and an antenna are provided. A wheel 20a of a first tire is provided with a first air pressure sensor 30a, a first transmitter 40a and a first antenna 50a. A wheel 20b of a second tire is provided with a second air pressure sensor 30b, a second transmitter 40b and a second antenna 50b. A wheel 20c of a third tire is provided with a third air pressure sensor 30c, a third transmitter 40c and a third antenna 50c. A wheel 20d of a fourth tire is provided with a fourth air pressure sensor 30d, a fourth transmitter 40d and a fourth antenna 50d. A wheel 20e of a fifth tire is provided with a fifth air pressure sensor 30e, a fifth transmitter 40e and a fifth antenna 50e.

The first wheel 20a, the second wheel 20b, the third wheel 20c, the fourth wheel 20d and the fifth wheel 20e are collectively referred to as “the wheels 20”. The first air pressure sensor 30a, the second air pressure sensor 30b, the third air pressure sensor 30c, the fourth air pressure sensor 30d and the fifth air pressure sensor 30e are collectively referred to as “the air pressure sensors 30”. The first transmitter 40a, the second transmitter 40b, the third transmitter 40c, the fourth transmitter 40d and the fifth transmitter 40e are collectively referred to as “the transmitters 40”. The first antenna 50a, the second antenna 50b, the third antenna 50c, the fourth antenna 50d and the fifth antenna 50e are collectively referred to as “the antennas 50”.

Each of the air pressure sensors 30 sends detected tire air pressure information to its corresponding transmitter 40. Each of the transmitters 40 transmits the received tire air pressure information via its corresponding antenna 50 to an antenna 72 of the car. The air pressure sensors 30 and the transmitters 40 can be driven by batteries (not shown).

A receiver 70 receives via the antenna 72 mounted to the car, the tire air pressure information from the transmitters 40. The receiver 70 is driven by a battery (not shown) installed in the car.

The receiver 70 sends the received tire air pressure information to an electronic control unit (referred to as “the ECU” hereinafter) 60. The ECU 60, as mentioned below, based on information sent from a user input unit 74, relates the received tire air pressure information with tire mounting locations, and shows them on a display unit 76 such as an LCD installed in the interior of the car. In this manner, a driver can see and know the present air pressure condition of each tire. The display unit 76 can be a monitor of a car navigation system.

The ECU 60 periodically monitors tire air pressures, and determines conditions of wheels 20 based on the tire air pressure information. If the tire air pressure is less than a predetermined threshold, the ECU 60 displays an alarm on the display unit 76 indicating the tire air pressure is low.

A reset switch 78 that may be installed in the interior of the car can reset information stored in the ECU 60. After the resetting, a user can input the relations between the identification signs and the tire mounting locations. The reset switch 78 is turned ON after mounting tires, rotating tires, replacing tires, etc.

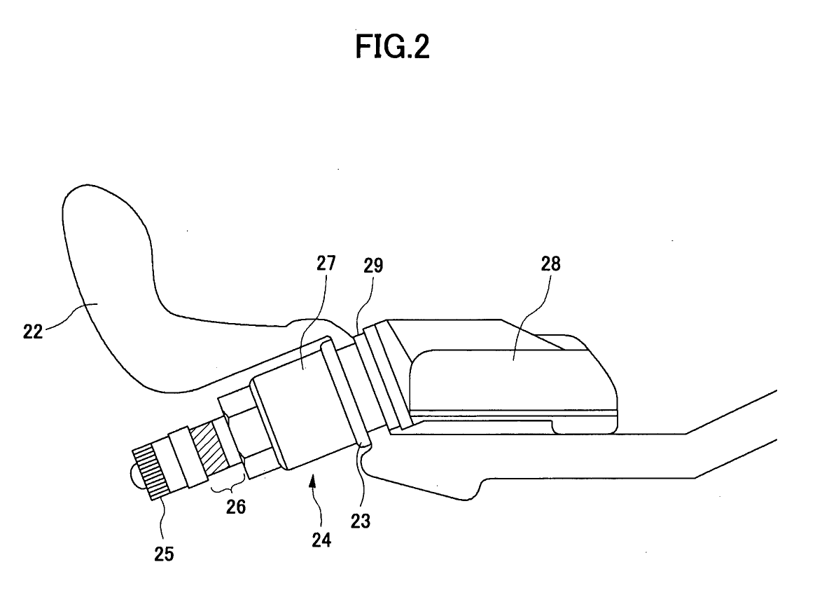

FIG. 2 illustrates how to mount the air pressure sensor 30 onto the wheel 20. The air pressure sensor 30 is integrated with a tire air valve and the transmitter 40 and constitutes a valve composition 24. Within a housing 28 of the valve composition 24, the air pressure sensor 30, the transmitter 40 and the antenna 50 (not shown) are mounted.

The valve composition 24 is inserted into a valve mounting hole made in a wheel rim 22 of the wheel 20. A resilient rubber grommet 29 is put around a portion of the valve composition 24 that penetrates the wheel rim 22, in order to maintain the air-tightness of the tire and protect the valve composition 24 from damage by vibration due to tire rotation. The valve composition 24 is fixed at the wheel rim 22 by fastening a nut 27 and a washer 23 from outside of the wheel rim 22. It is desired to adequately apply torque to the nut 27 in order to maintain the air-tightness of the tire and prevent the valve composition 24 from coming loose.

The valve composition 24 is provided with a valve cap 25 projecting to outside of the wheel rim. When the valve cap 25 is removed, a valve port (not shown) of a valve core is exposed. The valve port of the valve core communicates with the inside of the tire via a through-hole (not shown) of the valve core, in order to enable supplying air.

The air pressure sensor 30 may be a semiconductor pressure sensor, for example, that detects air pressure in the tire and the transmitter 40 transmits tire air pressure information to the car. The air pressure sensor 30 can continuously and constantly detect air pressure, or can do it periodically. In the latter case, the power consumption of the air pressure sensor 30 and the transmitter 40 can be reduced to extend the battery service life.

Different identification signs for each sensor may be attached to a valve portion 26 shown in FIG. 2, for example. FIG. 2 shows an example wherein each sensor is colored differently as identification. For example, the FR wheel, the FL wheel, the RR wheel, the RL wheel and the spare tire are colored red, blue, green, white and black, respectively. Any identification signs other than colors can be utilized as long as they can be monitored, understood and memorized. For example, numerical figures, symbols, alphabet letters, figures, and so on can be utilized. The attaching place of the identification signs is not limited to the valve portion 26. However, removable portions such as the valve cap 25 or nut 27 are undesired places, because it is feared that the relation with the air pressure sensors 30 might be lost.

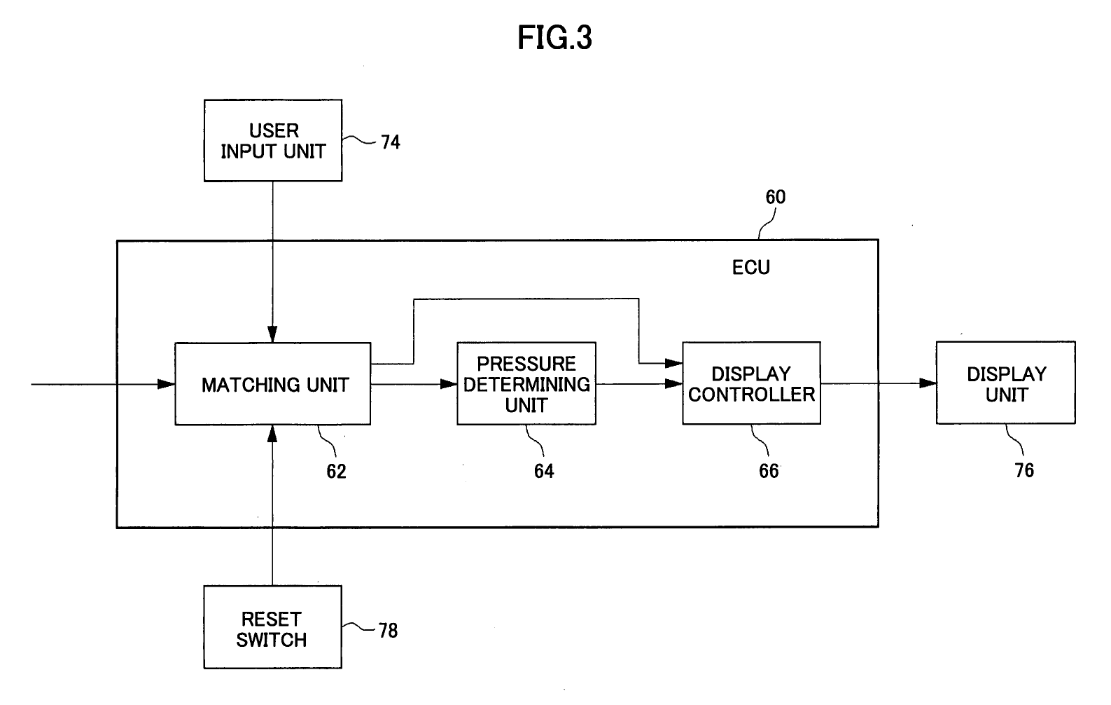

FIG. 3 is a block diagram showing a structure relating tire air pressure information display in the ECU 60. A method for displaying the tire air pressure information detected by the air pressure sensors 30 and tire mounting locations together with their corresponding relations on the display unit 76 is explained below.

Each of the air pressure sensors 30 is assigned its unique identification number (referred to as “sensor ID” hereinafter) when manufactured. The above mentioned identification signs for the air pressure sensors 30 are related to the sensor IDs. An example of such corresponding relations is shown in the following LIST 1, where the least significant digits of the sensor ID assigned to the air pressure sensors 30 are related to colors or alphabet letters.

LIST 1

| LSD of sensor ID | ID signs (Ex1) | ID signs (Ex2) |
|---|---|---|
| 0, 1 | red | A |
| 2, 3 | blue | B |
| 4, 5 | green | C |
| 6, 7 | white | D |
| 8, 9 | black | E |

In the LIST 1, Ex1 shows an example that the identification signs are colors, and Ex2 shows an example that the identification signs are alphabet letters. Any combination of identification signs is possible, but all identification signs assigned to the air pressure sensors 30 in a car should be different from each other.

The receiver 40 mounted at each wheel 30 transmits tire air pressure information detected by the air pressure sensor 30 and the sensor ID of the air pressure sensor 30 to the receiver 70 of the car. Since the sensor IDs and the identification signs are related to each other as mentioned above, the identification sign information is also transmitted to the car. The identification sign information can be transmitted separately to the car without such relating.

The tire air pressure information and the sensor IDs received via the receiver 70 are input to a matching unit 62 in the ECU 60. The matching unit 62 receives each combination of the sensor ID of the air pressure sensors 30 and the tire air pressure information detected by the air pressure sensors 30. The matching unit 62, however, cannot determine which tire air pressure information corresponds to which tire location, that is, FR wheel, FL wheel, RR wheel, RL wheel or the spare tire.

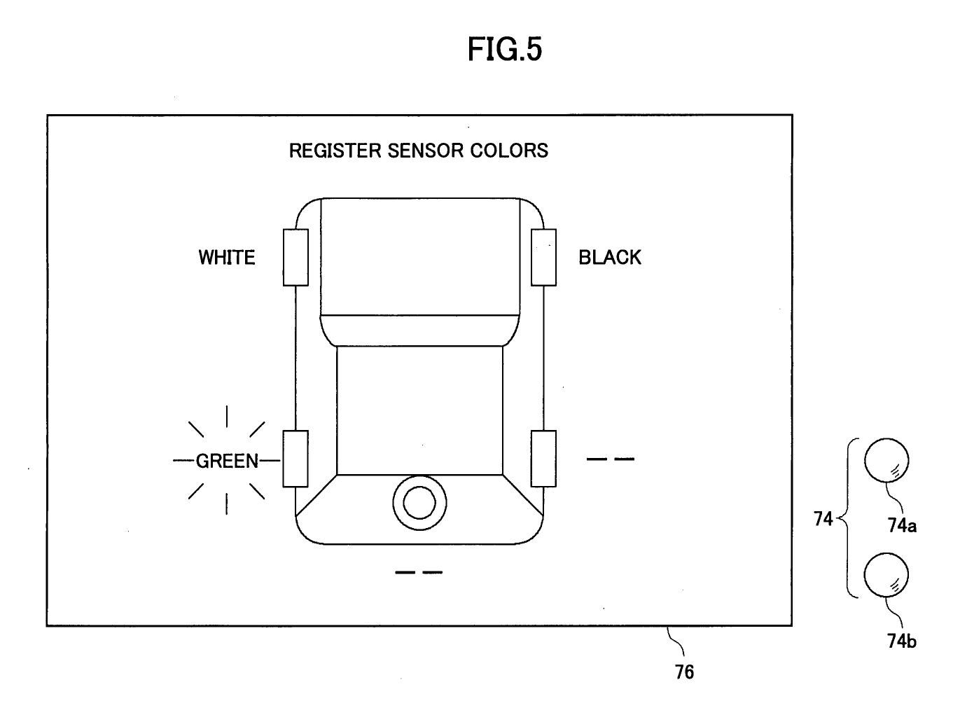

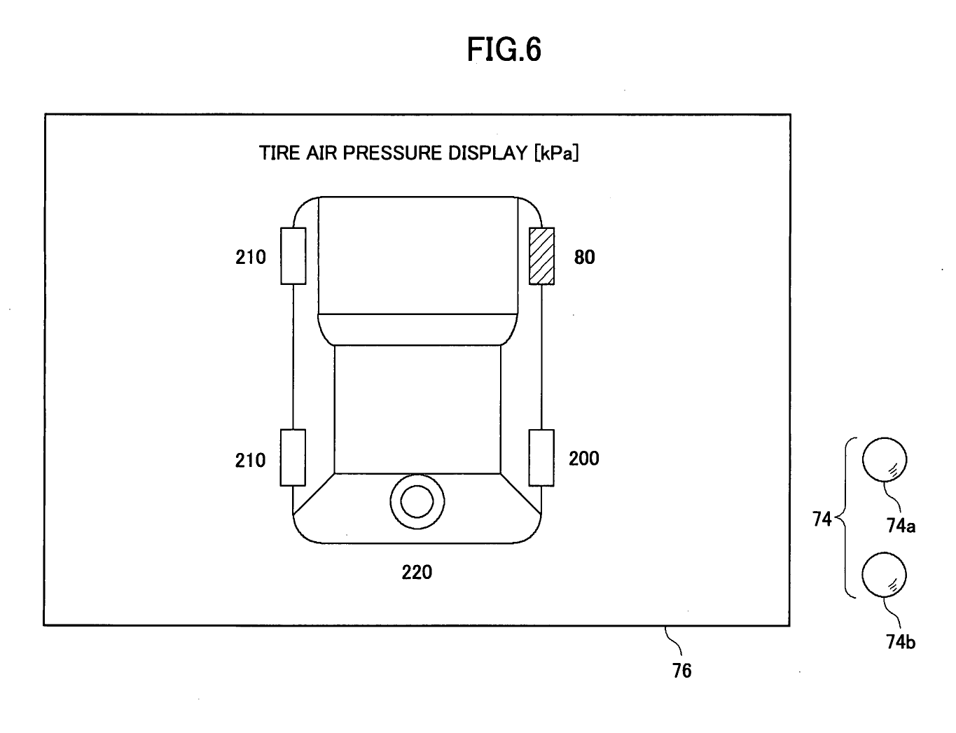

Then, a display controller 66 in the ECU 60 displays on the display unit 76, an image requesting that a user input corresponding relations between the identification sign of each air pressure sensor 30 and wheel mounting location. Then the user looks at the identification sign attached to the valve composition 24 of each wheel and inputs the indication signs corresponding to the tire mounting locations, for example “black” for the FR wheel, “white” for the FL wheel, and so on, using the user input unit 74. The display controller 66 displays an image for assisting the user to input, as shown in FIG. 5. After the user inputs the corresponding relations, the matching unit 6 can relate the tire air pressure information with wheel mounting location by utilizing the corresponding relations. The display controller 66 displays, on the display unit 76, the tire air pressure information with its related wheel mounting location, as shown in FIG. 6.

A pressure determining unit 64 periodically monitors the tire air pressure information of each wheel 20, and compares the tire air pressure information with a predetermined threshold to determine whether the tire air pressures are within the normal range. If one of the tire air pressures is determined to be abnormal by the pressure determining unit 64, the display controller 66 shows a tire air pressure abnormal alarm in the displays unit 76.

A car having only one antenna for receiving tire condition information transmitted from each tire, as shown in FIG. 1, cannot determine which wheel the received tire condition information is related to.

In this embodiment of the present invention, first the ECU 60 uses tire air pressure information and a sensor ID sent together from the transmitter 40 of each wheel 20, and makes a combination list of the tire air pressure information and the identification sign of the sensor that has detected the tire air pressure information. Next, a user inputs corresponding relations between the identification signs attached to wheels and the wheel mounting locations. Based on these two steps, the ECU 60 can show the tire air pressure and its related wheel mounting location. In this manner, when something occurs at a tire, the user can immediately recognize the location of the tire having an abnormal condition without looking at the tire or its identification sign.

And as mentioned above, as long as there are corresponding relations between the sensor IDs and the identification signs, it is not necessary in a factory to input corresponding relations between the sensor IDs and the identification signs to the ECU 60. If the car receives the identification numbers of the sensors, it can also obtain the identification sign information, and it is not required to transmit the identification sign information from wheels to the car, reducing the amount of data transmission.

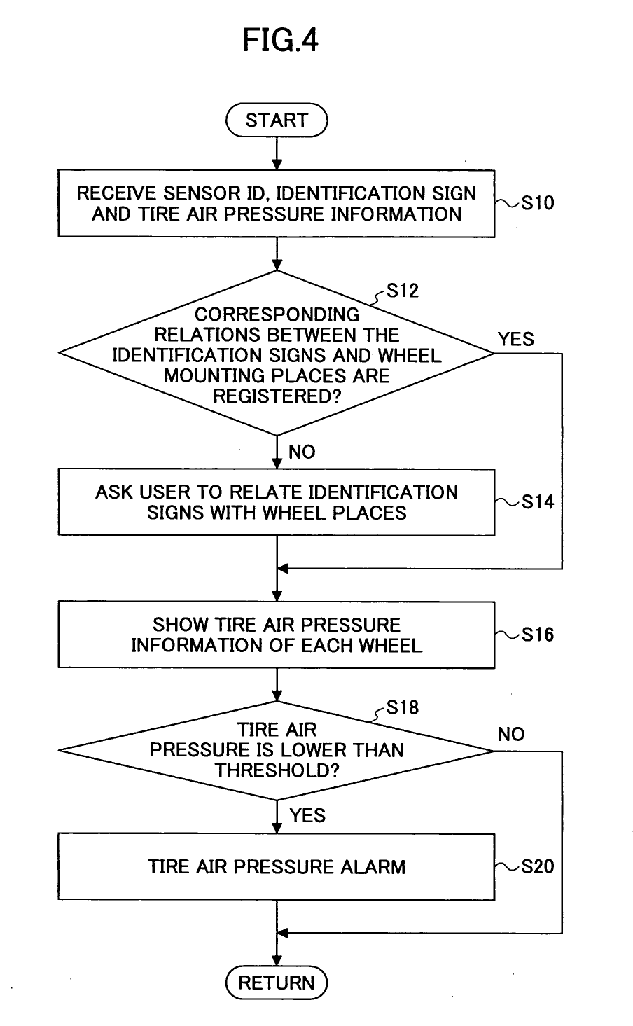

Next, referring to a flowchart shown in FIG. 4, a procedure flow of setting the tire condition display unit, displaying tire air pressure information and tire air pressure alarming is provided. First, the ECU 60 receives via the receiver 70 tire air pressure information and a sensor ID from each wheel 20 (S10). Next, the matching unit 62 confirms whether corresponding relations between the identification sign of each air pressure sensor 30 and a wheel mounting location are registered in the matching unit 62 (S12). If the reset switch 78 is turned ON and corresponding relation is reset (NO at S12), for example, immediately after mounting a wheel or rotating wheels, the display controller 66 shows on the display unit 76 an image requesting that a user input corresponding relations between identification signs and wheel mounting locations (S14).

FIG. 5 is an example of such an identification sign setting image shown on the display unit 76. FIG. 5 shows the display unit 76 and neighboring buttons 74a and 74b as the user input unit 74. The display unit 76 may be an LCD for example, and mounted at a place in the interior of the car where the user can see it.

In the screen of FIG. 5, a top plan view of the car 12 and mounting locations of the wheels 20 are shown. Next to each wheel, correct identification signs of corresponding air pressure sensors can be selected by the user. In FIG. 5, “black” is already selected for the FR wheel, and “white” is already selected for the FL wheel. As for the RR wheel and the spare tire, no selection has been made. As for the RL wheel, the “green” sign is blinking to indicate that selection is being made at present. The user hits the wheel location selection button 74a to select a wheel location to be set for the identification sign. At the wheel location selected, whenever hitting the identification sign selection button 74b, the color indication is changed in order of red, blue, green, white and black. The user selects the right color which he looks at for each wheel. A color already selected for one wheel may no longer be selected for another wheel. The arrangement and types of buttons 74a and 74b are freely designable. Colors may be indicated by characters as shown in FIG. 5; alternatively, colors may be indicated by lighting colored lamps. If the identification signs are alphabet letters, whenever hitting the identification sign selection button 74b, the indication is changed in order of A, B, C, D and E. If the display unit 76 is a touch panel, the buttons 74a, 74b can be shown on the screen. A button for displaying again the set identification signs and corresponding wheel locations may be provided, in order to enable reconfirmation of setting. After setting the identification signs for every wheel 20 is finished, the procedure goes to the next step.

In a case where the user inputs corresponding relations between the identification signs and wheel mounting locations, or where it is confirmed that the corresponding relations are already registered in the matching unit 62 (Yes at S12), the display controller 66 shows on the display unit 76 the wheel mounting locations and their corresponding tire air pressure information (S16). An example of such a screen of tire air pressure display is shown in FIG. 6. Similar to the identification sign setting screen shown in FIG. 5, a top plan view of the car 12 and the wheel mounting locations are shown, and next to each wheel, its corresponding tire air pressure information is displayed.

Next, the pressure determining unit 64 determines whether a tire air pressure transmitted from each wheel 20 becomes less than a predetermined threshold (S18). When the tire air pressure is higher than or equal to the threshold (No at S18), this routine ends. When the tire air pressure is lower than the threshold (Yes at S18), the display controller shows a tire air pressure alarm on the display 76 (S20). In FIG. 6, since the tire air pressure of the RF wheel is lower than a predetermined threshold, the FR wheel and its tire air pressure are highlighted to provide alarm to a user about that. Together with such a highlight display, an alarming sound or an alarming screen can be used.

As above explained, according to the embodiment of the present invention, when a user inputs corresponding relations between identification signs and wheel mounting locations, a screen as shown in FIG. 5 appears on the display unit 76. Therefore, the user can input them while confirming the wheel mounting locations, and after inputting, the user can reconfirm the input corresponding relations, and can avoid inputting error. Since corresponding relations between sensor IDs and wheel locations are not required to be input, setting after tire rotation becomes easy.

Since wheel mounting locations of a car and corresponding tire air pressures are displayed on a screen as shown in FIG. 6, a driver can easily grasp the tire condition of each wheel while sitting in the car. When an abnormal condition occurs at a tire, a user does not have to look at the tire or find an identification sign at each wheel, but the user can immediately grasp which tire is under abnormal condition.

According to the embodiment of the present invention, a user can input corresponding relations between wheel mounting locations and identification signs, and therefore a wheel determination step required in the prior art is not required even if a car has only one or two antennas for receiving information from wheels. The tire condition information transmitted from each wheel can be utilized immediately after starting the car without additional measurement.

Although the present invention is explained based on the embodiments thereof, it is not limited to these embodiments, but various variations and modifications may be made without departing from the scope of the present invention. Some of such variations and modifications are explained below.

According to the present invention, conditions other than tire air pressures can be displayed with corresponding tire locations. For example, instead of air pressure sensors, other sensors can be provided for detecting tire temperatures, wet/dry information of road-holding faces, tire wearing amount, acceleration, tire distortion, and other conditions. As one example, if a temperature sensor is mounted to each wheel, each wheel and temperature thereof at present can be displayed on a screen similar to that shown in FIG. 6. When one of the tire temperatures becomes higher than a predetermined temperature, an alarm is made. The same can be done for other conditions.

Depending on the number of conditions to be monitored, a required number of sensors can be mounted to wheels 20, to show values detected by these sensors with corresponding wheel locations.

Instead of an LCD as the display unit 76 in the interior of the car, an LED can be used. The display unit 76 is not limited to being placed in the interior of the car, and can be placed outside of the car. A transmitter may be provided in the car 12 for transmitting screen information to outside of the car, and tire air pressure information of each wheel can be shown on a display of a handy type testing device or computer.

The present application is based on Japanese Priority Application No. 2004-006139 filed on Jan. 13, 2004 with the Japanese Patent Office, the entire contents of which are hereby incorporated by reference.

1. A tire condition display device comprising:
a plurality of sensors for detecting tire condition, each of the sensors being mounted at a wheel of a vehicle and having a different identification sign at an observable place;
a transmitter mounted at each wheel, for transmitting the tire condition information detected by the sensor and the identification sign information;
a user input unit for receiving corresponding relations between the identification signs and their corresponding wheel locations in the vehicle; and
a display unit for displaying the tire condition information and the corresponding wheel locations, based on the received corresponding relations.

2. The tire condition display device as claimed in claim 1, wherein the display unit shows the corresponding relations between the identification signs and the wheel locations, whereby a user can visually confirm the corresponding relations when inputting.

3. The tire condition display device as claimed in claim 1, further comprising:
a determining unit for determining a tire abnormal condition based on the tire condition information; wherein
the display unit displays the location of the tire determined to be abnormal.

4. The tire condition display device as claimed in claim 2, further comprising:
a determining unit for determining a tire abnormal condition based on the tire condition information; wherein
the display unit displays the location of the tire determined to be abnormal.

5. The tire condition display device as claimed in claim 1, wherein each of the sensors is previously assigned a unique identification number and the identification signs and the identification numbers are related to each other.
